(19) United States
(12) Patent Application Publication
(10) Pub. No.: US 2009/0297163 A1
(43) Pub. Date: Dec. 3, 2009

(54) Reference-clock selection circuit and reference-clock selection method

(75) Inventors: Yoshiaki Shibayama, Kawasaki (JP); Sunao Itou, Kawasaki (JP); Wataru Kawasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/382,912

(22) Filed: Mar. 26, 2009

(30) Foreign Application Priority Data
Jun. 2, 2008 (JP) 2008-145070

(51) Int. Cl. H04B 10/00

(52) U.S. Cl. 398/154

(57) ABSTRACT

A reference-clock selection circuit for a communication interface apparatus in which signals are input via a plurality of channels includes an insertion-stuff-bit-amount monitoring unit that monitors an insertion stuff bit amount to be inserted in the signal; a channel detecting unit that detects a channel where the insertion stuff bit amount inserted in the signal matches an insertion stuff bit amount of a reference signal from a reference clock oscillator; and a reference-clock selecting unit that selects the detected channel as a reference clock for network synchronization of a connected network.

### CROSS-REFERENCE TO RELATED APPLICATION

This application is based upon and claims the benefit of priority of the prior Japanese Patent Application No. 2008-145070, filed on Jun. 2, 2008, the entire contents of which are incorporated herein by reference.

### FIELD

The embodiments discussed herein are directed to a reference-clock selection circuit, reference-clock selecting method, and communication interface apparatus for multiplexing a plurality of optical signals and electrical signals based on a reference clock.

### BACKGROUND

Computer network communications via the Internet, for example, take on increasing importance drastically, and the communication speed of computer network communications is also desired to be further faster. For example, the Internet has a backbone line as a trunk transmission path, and a wide-band optical communication technology called wavelength Division Multiplex (WDM) is generally used as the backbone line.

WDM is a technology allowing large-capacity bidirectional high-speed data communications by transmitting light beams of different wavelengths via a single optical fiber for multiplexing channels. In WDM, what currently goes mainstream is that four channels each having a transmission speed of 2.5 Gb/s per wavelength are multiplexed to achieve a transmission speed of 10 Gb/s.

An optical interface apparatus connecting a WDM line and a client line has an optical wavelength multiplexing/demultiplexing apparatus disposed on a WDM-line side. The optical wavelength multiplexing/demultiplexing apparatus multiplexes optical signals from the client line and sends the result to the WDM line, and multiplexes/demultiplexes an optical signal from the WDM line and distributes the result to each optical interface apparatus.

Also, on a client line side of the optical interface apparatus connecting the WEDM line and the client line, an optical interface apparatus is disposed. The optical interface apparatus includes a plurality of optical interface units. These optical interface units have a function of adding overhead information to optical signals of a plurality of channels from the client line for multiplexing and passing to the optical wavelength multiplexing/demultiplexing apparatus.

Meanwhile, since the WDM line and the client line are different networks, clock unification called network synchronization has to be performed to establish a mutual communication. To establish a communication between different networks, various network synchronization techniques and network synchronizing apparatuses have been suggested in conventional technologies.

One of these conventional technologies is a slave synchronization technique in which a clock oscillator that oscillates a fixed clock with high accuracy and reliability (that is, with a small deviation) is placed in a clock reference station in a network and the fixed clock oscillated by the clock oscillator of the clock reference station is distributed to other stations.

In the slave synchronization technique, to distribute the fixed clock oscillated by the clock oscillator of the clock reference station to other station, a specific one of channels of a connection line has to be allocated as a channel dedicated to a fixed clock path.

The conventional technologies are exemplarily disclosed in Japanese Laid-open Patent Publication No. 11-127128 and Hiroyuki Kasai and two others, “Section Five: Network synchronizing apparatus, 5.1 What is network synchronization?” in “Multimedia Network Series: SDH transmission system”, Ohmsha Ltd., September 1993.

However, in the conventional technologies, since a specific channel is taken as a channel dedicated to a fixed clock path, the user cannot use this channel for normal data communications. That is, for network synchronization, the user has to be aware that the specific channel is a channel dedicated to a fixed clock path.

Therefore, when an operation test is performed at the time of placing an optical interface apparatus on-site without consideration of the specific channel being a channel dedicated to a fixed clock path, inconvenience may occur.

That is, depending on the state of interface connection with an external communication apparatus, so-called Phase Locked Loop (PLL) loop island state or the like occurs, for example, thereby disadvantageously causing an asynchronous state in clock with the external communication apparatus and a lack of signal communication.

### SUMMARY

According to an aspect of the invention, a reference-clock selection circuit for a communication interface apparatus in which signals are input via a plurality of channels includes an insertion-stuff-bit-amount monitoring unit that monitors an insertion stuff bit amount to be inserted in the signal input via each of the channels; a channel detecting unit that detects, from among the channels, a channel where the insertion stuff bit amount inserted in the signal matches an insertion stuff bit amount of a reference signal based on a reference clock generated by a reference clock oscillator; and a reference-clock selecting unit that selects the channel detected by the channel detecting unit as a reference clock for network synchronization of a connected network.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of the configuration of a WDM interface apparatus according to an exemplary embodiment;

FIG. 2 is a block diagram of the configuration of an optical interface unit according to the exemplary embodiment;

FIG. 3 is a flowchart of a reference-clock selecting process according to the exemplary embodiment;

FIG. 4 is a block diagram that schematically depicts the configuration of a WDM interface apparatus according to a conventional technology;

FIG. 5 is a drawing for explaining an exemplary test for continuity of an optical interface apparatus; and

FIG. 6 is a drawing for explaining a PLL loop island state.

### DESCRIPTION OF EMBODIMENTS

Preferred embodiments of the reference-clock selection circuit, reference-clock selecting method, and communication interface apparatus according to the present invention will be explained with reference to the accompanying drawings. Here, although the reference-clock selection circuit, reference-clock selecting method, and communication interface apparatus discussed below relates to a WDM interface apparatus and WDM interface unit for optical communications, this is not meant to be restrictive, and may relate to an interface apparatus and interface unit for electrical communications. In the following, a “channel” is abbreviated as “CH”.

WDM is internationally standardized as Optical Transport Unit 1 (OTU1) to Optical Transport Unit 3 (OTU3) in Optical Transport Network (OTN: an optical transmission standard recommended in 2000 by International Telecommunication Union Telecommunications Standardization Sector (ITU-T)). OTU1 is a WDM standard achieving a transmission rate of approximately 2.666 Gb/s. OTU2 is a WDM standard achieving a transmission rate of approximately 10.709 Gb/s. OTU3 is a WDM standard called Dense Wavelength Division Multiplex (DWDM) standard achieving a transmission rate of approximately 43.018 Gb/s.

On the other hand, the transmission rate of a client-side line is varied, such as approximately 2.488 Gb/s, approximately 9.953 Gb/s, and approximately 39.813 Gb/s. To connect the client-side line and the WDM line, a digital wrapper technique is performed to solve a gap in transmission rate between these lines.

In one exemplary case, one CH of a client-side line with a transmission rate of approximately 2.488 Gb/s is subject to digital wrapper to OTU1. In another exemplary case, one CH of a client-side line with a transmission rate of approximately 9.953 Gb/s is subjected to digital wrapper to OTU2. In still another exemplary case, one CH of a client-side line with a transmission rate of approximately 39.813 Gb/s is subjected to digital wrapper to OTU3.

In still another exemplary case, four CHs on a client-side line with a transmission rate of approximately 2.488 Gb/s are multiplexed to OTU2 for digital wrapper. In still another exemplary case, four CHs on a client-side line with a transmission rate of approximately 9.953 Gb/s are multiplexed to OTU3 for digital wrapper. In the exemplary embodiment below, it is assumed that four channels on a client-side line are multiplexed to OTU2 or OTU3 for digital wrapper.

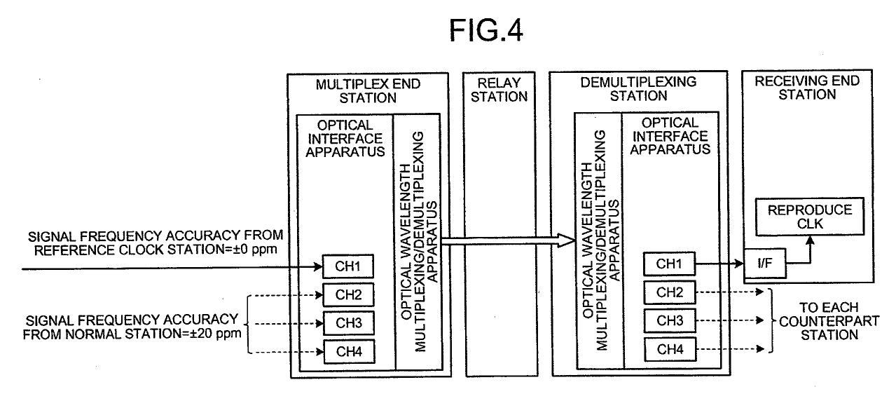

Prior to the explanation of the exemplary embodiment of the reference-clock selection circuit, reference-clock selecting method, and communication interface apparatus, problems of a conventional reference-clock selecting method and communication interface apparatus are explained with reference to FIGS. 4 to 6.

FIG. 4 is a block diagram that schematically depicts the configuration of a WDM interface apparatus according to a conventional technology. In FIG. 4, an optical interface apparatus and optical wavelength multiplexing/demultiplexing apparatus are collectively referred to as an optical multiplexing apparatus. In the optical multiplexing apparatus as depicted in the drawing, synchronization of the entire transmission network is performed based on a reference clock with a frequency accuracy of ±0 parts per million (one part per 10⁻⁶) from a reference clock station (that is, with a small clock deviation). Conventionally, as depicted, any one of a plurality of channels has to be fixedly operated as the one dedicated to a clock path.

For this reason, for example, when a WDM interface apparatus is placed on-site, an operator has to be always aware that a specific channel is a channel dedicated to a fixed clock path (this is hereinafter also referred to as an operation restriction). If the operator makes a network connection or performs a test for continuity as forgetting that a specific channel is a channel dedicated to a fixed clock path, the WDM interface apparatus is asynchronous with the connected network or an apparatus under test, thereby making signal communication impossible.

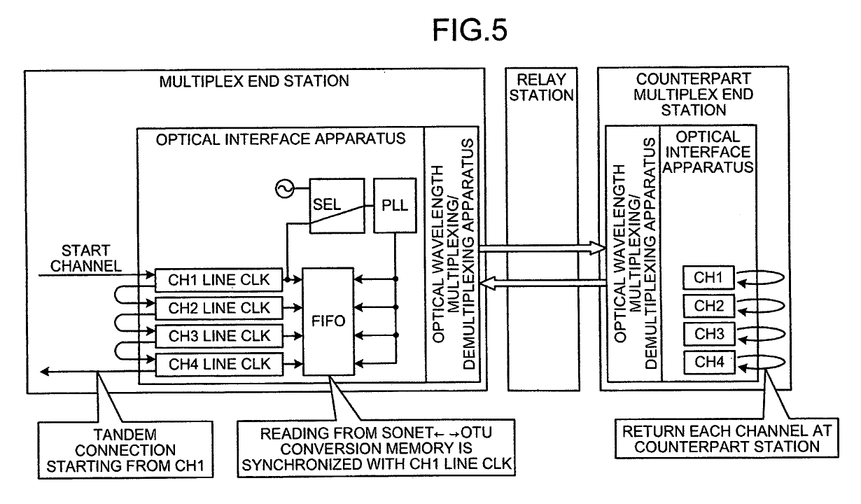

For example, when a WDM interface apparatus is placed on-site, it is assumed that a test for continuity is performed with a connection as depicted in FIG. 5. That is, it is assumed that a signal of a reference clock is input from an apparatus for test or a connected communication apparatus of the WDM interface apparatus to CH1 of an optical interface apparatus of a multiplex end station. An output from CH1 is input via an optical wavelength multiplexing/demultiplexing apparatus of the multiplex end station, a relay station, and then an optical wavelength multiplexing/demultiplexing apparatus of a counterpart multiplex end station to CH1 of an optical interface apparatus of the counterpart multiplex end station.

In CH1 of the optical interface apparatus of the counterpart multiplex end station, a return connection of directly connecting an input and output is performed. With this, an output signal from CH1 of the optical interface apparatus of the multiplex end station is returned at CH1 of the optical interface apparatus of the counterpart multiplex end station to be looped back to its own channel.

Furthermore, CH1 of the optical interface apparatus of the multiplex end station inputs the looped-back signal to CH2 of the same optical interface apparatus. In CH2 of the optical interface apparatus of the counterpart multiplex end station, a return connection of directly connecting an input and output is performed. With this, an output signal from CH2 of the optical interface apparatus of the multiplex end station is returned at CH2 of the optical interface apparatus of the counterpart multiplex end station to be looped back to its own channel.

CH2 of the optical interface apparatus of the multiplex end station then inputs the looped-back signal to CH3 of the same optical interface apparatus. In CH3 and CH4 of the optical interface apparatus of the counterpart multiplex end station, a return connection of directly connecting an input and output is performed, as with CH1 and CH2 thereof. Also, CH3 inputs the loop-back signal from CH3 of the counterpart multiplex end station to CH4 of the same optical interface apparatus.

Finally, CH4 outputs a loop-back signal from CH4 of the counterpart multiplex end station to the apparatus for test or the connected communication apparatus of the WDM interface apparatus. An example of such a connection in a test for continuity is referred to as a tandem connection.

As depicted in FIG. 5, in the case of settings according to the operation restriction, initially, due to an optical input break of CH1 (that is, Line Clock (CLK) break), an internal CLK SEL (a selector represented in the drawing as “SEL”) selects an internal oscillator (represented in the drawing as a circuit symbol indicative of an oscillator).

When CH1 is recovered from the optical input break, the internal CLK SEL is switched to CH1 Line CLK, thereby achieving signal communication with all channels (CH2 to CH4) synchronous in clock with CH1.

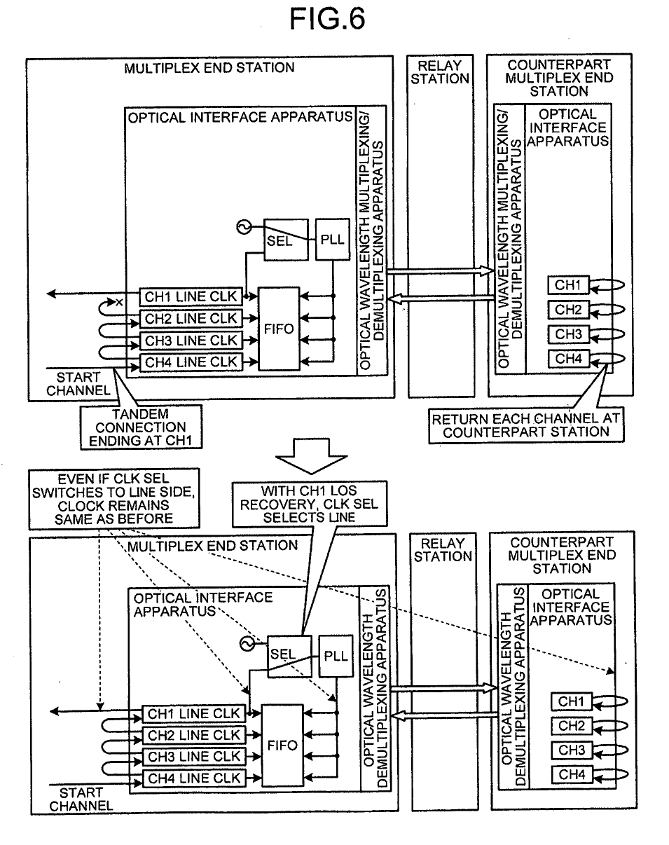

It is assumed that the signal with the reference clock is defined in advance as being input from CH1. However, as depicted in FIG. 6, it is assumed that the apparatus for test of the WDM interface apparatus or the connected apparatus and the optical interface apparatus of the multiplex end station are connected to a channel other than CH1, for example, CH4.

In the example of FIG. 6, even through CH1 is a channel dedicated to a clock path, the connection starts from CH4 to CH3, CH2, and then CH1 to form a tandem connection. Initially, due to an input break of CH1 (Line synchronization clock break), the internal CLK SEL (the selector represented in the drawing as “SEL”) selects the internal oscillator (represented in the drawing as a circuit symbol indicative of an oscillator).

However, when CH1 is recovered from the input break, even if the internal CLK SEL switches to CH1 Line CLK, the clock is still in synchronization with the internal oscillator, thereby being asynchronous with the reference clock and making signal communication impossible. This is because CH1 Line CLK's clock synchronization with the internal oscillator has already been established in the inside of the multiplexing apparatus.

The phenomenon explained above is referred to as a “PLL loop island state”. The exemplary embodiment solves the inconvenience, including the “PLL loop island state”, that the apparatus is asynchronous with the reference clock even if a channel with the reference clock is recovered from an input break, thereby making signal communication impossible.

### Exemplary Embodiment

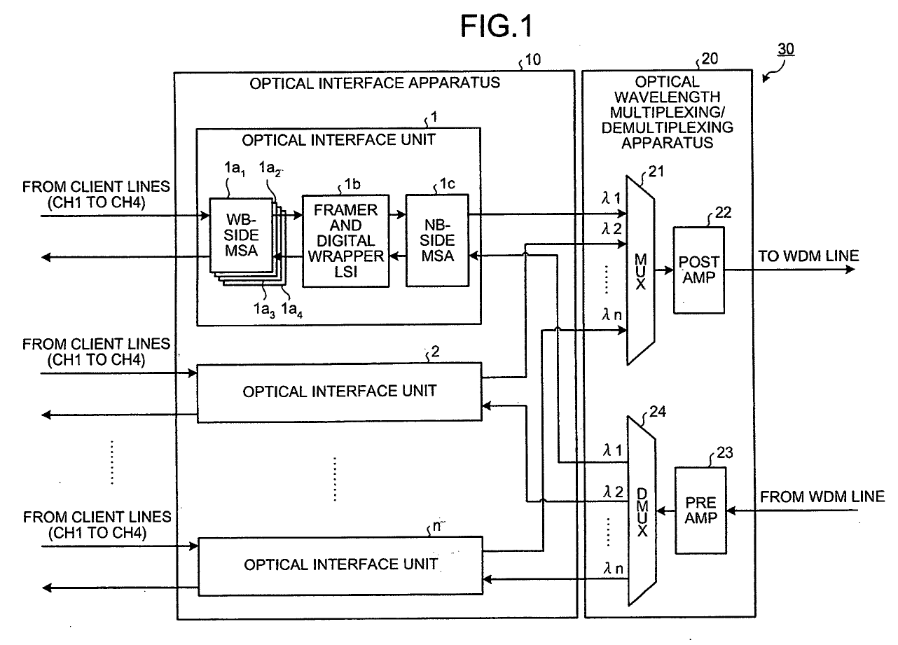

With reference to FIGS. 1 to 3, the exemplary embodiment is explained. FIG. 1 is a block diagram of the configuration of a WDM interface apparatus according to the exemplary embodiment. As depicted in the drawing, a WDM interface apparatus 30 according to the exemplary embodiment is configured to have an optical interface apparatus 10 disposed on a client-line side and an optical wavelength multiplexing/demultiplexing apparatus 20 disposed on a WDM-line side.

The optical interface apparatus 10 includes n (n is a natural number satisfying 1≦n) optical interface units 1, 2, . . . n. Since each optical interface unit has the same configuration and function, the configuration and function of the optical interface unit typified by the optical interface unit 1 is explained.

The optical interface unit 1 includes Wide Band (WB)-side Multi Source Agreements (MSAs) 1ₐ₁, . . . , 1ₐ₄ for each four channel, a framer and digital wrapper Large-Scale Integrated circuit (LSI) 1b, and a Narrow Band (NB)-side MSA 1c disposed on a WDM-line side. Components other than these are not explained and depicted herein.

In the exemplary embodiment, it is assumed that four channels, for example, from a client line are multiplexed with one optical interface unit. However, the number of channels subjected to signal multiplexing is not restricted to four.

The WB-side MSAs 1ₐ₁, . . . , 1ₐ₄ and the NB-side MSA 1c are optical modules each having integrated therein an Optical Signal/Electrical Signal (O/E) conversion circuit that converts an optical signal to an electrical signal, an E/O conversion circuit that converts an electrical signal to an optical signal, a Clock Data Recovery (CDR) that separates a signal obtained by superposing a clock signal on a data signal into the clock signal and the data signal, and a SERializer/DESerializer (SERDES) for interconversion between a serial signal and a parallel signal.

The framer and digital wrapper LSI 1b processes an input signal from the client-line side converted to an electrical signal, monitors header information of the electrical signal, and detects a break in the input signal from the client-line side. Furthermore, the framer and digital wrapper LSI 1b performs a Digital wrapper (DW) process of adding a channel header and Forward Error Correction (FEC) before and after a frame of the electrical signal, and then passes the result to the NB-side MSA 1c.

Also, the framer and digital wrapper LSI 1b processes an input signal from the WDM-line side converted to an electrical signal, monitors header information of the electrical signal, and detects a break in the input signal from the WDM line side. Furthermore, the framer and digital wrapper LSI 1b processes an input signal from the client-line side converted to an electrical signal, monitors header information of the electrical signal, and detects a break in the input signal from the client-line side.

Furthermore, the framer and digital wrapper LSI 1b performs a Decoding-Digital Wrapper (D-DW) process of removing the added channel header and FEC before and after the frame of the electrical signal, and performs channel separation on the electrical signal for passing to corresponding WB-side MSAs 1ₐ₁, . . . , 1ₐ₄.

The optical wavelength multiplexing/demultiplexing apparatus 20 includes a MUltipleXers 21 that wavelength-multiplexes optical signals with wavelengths of λ1, . . . , λn sent from the client line via n optical interface units 1, 2, . . . , n of the optical interface apparatus 10.

Also, the optical wavelength multiplexing/demultiplexing apparatus 20 includes a post amplifier (AMP) 22 that amplifies an optical signal obtained through wavelength multiplexing by the MUX 21 at a stage subsequent to the MUX 21. The optical signal amplified by the post AMP 22 is then sent to the WDM line.

Furthermore, the optical wavelength multiplexing/demultiplexing apparatus 20 includes a pre AMP 23 that amplifies the optical signal obtained through wavelength multiplexing and sent from the WDM line at a stage prior to the process by a DeMUltipleXer (DMUX) 24, which will be explained further below. Still further, the optical wavelength multiplexing/demultiplexing apparatus 20 includes the DMUX 24 that demultiplexes wavelength multiplexing of the optical signal obtained through amplification by the pre AMP 23. The optical signal is multiplexed/demultiplexed by the DMUX 24 to signals with wavelengths of λ1, . . . , λn, and these signals are input to n optical interface units 1, 2, . . . , n, respectively, of the optical interface apparatus 10.

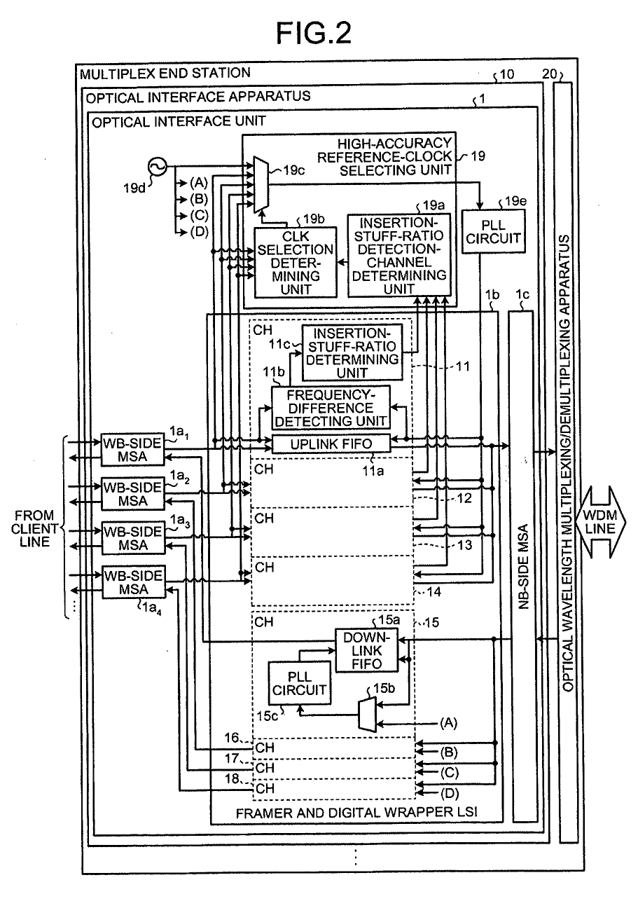

Next, with reference to FIG. 2, the configuration of the optical interface unit according to the exemplary embodiment is explained. The optical interface unit 1 according to the exemplary embodiment forms the optical interface apparatus 10 accommodated in the multiplex end station. Also, in the multiplex end station, the optical wavelength multiplexing/demultiplexing apparatus 20 is connected to a WDM-line side of the optical interface unit 1.

The optical interface unit 1 includes the WB-side MSAs 1ₐ₁, . . . , 1ₐ₄, the framer and digital wrapper LSI 1b, the NB-side MSA 1c, a high-accuracy reference-clock selecting unit 19, and an oscillator 19d.

The framer and digital wrapper LSI 1b includes CH11, . . . , CH14 and CH15, . . . , CH18. For example, CH11 includes an uplink First In First Out (FIFO) (which buffers data according to FIFO control) 11a, a frequency-difference detecting unit 11b, and an insertion-stuff-ratio determining unit 11c.

Also, CH15 includes a downlink FIFO 15a that buffers a signal from the WDM-line side for output to the WB-side MSA 1ₐ₁, a selector 15b that selects either one of a clock signal from the WDM-line side and a clock signal from a PLL circuit 19e, and a PLL circuit 15c that performs phase control over the clock selected by the selector 15b.

Here, in FIG. 2, only WB-side MSA 1ₐ₁, CH11, and CH15 are explained. Since the explanation can be similarly applied to “the WB-side MSA 1ₐ₂ and CH12 and CH16” to “the WB-side MSA₁ₐ₄, CH14 and CH16”, these are not explained or depicted herein.

The high-accuracy reference-clock selecting unit 19 includes an insertion-stuff-ratio detection-channel determining unit 19a, a CLK selection determining unit 19b, and a selector 19c. One of inputs to the selector 19c is a clock signal oscillated by the oscillator 19d. At the time of a break in an input signal from the client line, the clock signal oscillated by the oscillator 19d oscillates a clock signal as an alternative in the optical interface unit.

Also, the high-accuracy reference-clock selecting unit 19 has connected thereto the PLL circuit 19e that performs phase synchronization of the clock signal. The clock signal output from the high-accuracy reference-clock selecting unit 19 is input to the PLL circuit 19e for phase synchronization. The phase-synchronized clock signal serves as a read clock for the uplink FIFO 11a.

An optical signal input to the WB-side MSA 1ₐ₁ is converted to an electrical signal by the WB-side MSA 1ₐ₁ for input to the uplink FIFO 11a. The separated clock is serves as a write clock signal for the uplink FIFO 11a, and is input to the CLK selection determining unit 19b and the selector 19c of the high-accuracy reference-clock selecting unit 19.

The uplink FIFO 11a buffers data of the electrical signal input from the WB-side MSA 1ₐ₁, and the frequency of the input clock signal is detected by the frequency-difference detecting unit 11b as a write frequency (WC). Also, in the uplink FIFO 11a, the frequency of a read clock signal input from the PLL circuit 19e is detected by the frequency-difference detecting unit 11b as a read frequency (RC).

The frequency-difference detecting unit 11b detects a frequency difference between WC and RC of the uplink FIFO 11a. Based on the frequency difference detected by the frequency-difference detecting unit 11b, the insertion-stuff-ratio determining unit 11c calculates an insertion stuff ratio at CH11. The insertion stuff ratio is a ratio of stuff bits per unit time inserted to data to absorb a frequency difference between the input frequency and the internal clock.

With the selector 19c selecting the oscillator 19d, the write clock and the read clock of the uplink FIFO of each channel are compared with each other in frequency, and the ratio of stuff to be inserted is calculated from the frequency difference found through comparison.

Then, in the insertion-stuff-ratio detection-channel determining unit 19a, the insertion stuff ratios of the respective channels are compared with each other. Here, when four CHs of 2.48832 Gb/s are multiplexed to OTU2, since it is known that a transmission-path frequency deviation is 0 with an insertion stuff ratio of approximately 17.65 parts per million, a channel with an insertion stuff ratio being closest to approximately 17.65 parts per million is determined.

Also, for example, when four CH of 9.95328 Gb/s is multiplexed to OTU3, since it is known that a transmission-path frequency deviation is 0 with an insertion stuff ratio of approximately 35.46 parts per million, a channel with an insertion stuff ratio being closest to approximately 35.46 parts per million is determined.

In this manner, based on the determination of the channel with an insertion stuff ratio closest to the predetermined value, the CLK selection determining unit 19b determines the only channel as a channel for transmitting a reference clock and selects the channel. Based on the selection result, the selector 19c makes a switch so as to input the only clock of the relevant channel.

Here, the CLK selection determining unit 19b monitors the channel structure and a clock transmission state of each channel. For example, the CLK selection determining unit 19b monitors warning information, such as an input signal break and recovery from an input signal break for each channel. Depending on this monitoring result, with the insertion-stuff-ratio detection-channel determining unit 19a, even a channel determined as having an insertion stuff ratio closest to the predetermined value is controlled so that a clock signal of the relevant channel is not selected.

A method of calculating an insertion stuff ratio in the case of 0 staff disclosed in APPENDIX I of ITU-T G. 709 is explained below. Here, variables and parameters for use in the following equations are defined in advance.

ODUk: the name of ODU that stores a client signal. For example, when ODU1 is stored in ODU2, k=2.

ODUj: the client name of ODU to be stored. For example, when ODU1 is stored in ODU2, j=1.

N: the number of fixed stuff bytes of ODUj (payload region) of ODUk storing a client.

S: 155 in nominal Synchronous Transport Module (STM)-N (Synchronous Optical NETwork/Synchronous Digital Hierarchy (SONET/SDH)). A logic line of 52 megabits per second is taken as a unit for multiplexing, and is called STM-1. N is 155 (representing a multiple of 52 megabits per second for the transmission rate). Or, an ODUj client speed (bits per second)

T: a nominal ODUk frame time (seconds)

yc: a client-signal frequency offset (parts per million)

ys: a server (indicative of synchronous CLK for multiplexing)—signal frequency offset (parts per million)

p: a ratio of an ODUk payload region usable by a client signal

Nf: an average number of client signals mapped onto an ODUk frame for a specific frequency offset (indicative of a value obtained through averaging over many frames)

According to the definitions, Nf can be represented by the following equation.

$$Nf = S T \cdot \frac{1 + yc}{1 + ys} \qquad ( 1 )$$

Here, when the frequency offsets yc and ys are extremely small, Nf is approximated by the following equation.

Nf≅ST(1+yc−ys) (2)

Here, β is defined by the following equation.

β≡1+yc−ys (3)

The average number Nf of client bytes mapped onto an ODUk frame is obtained by subtracting the number of fixed stuff bytes (N) for the relevant client from the total number of bytes (4×3,808×p=15,232×p) in the payload area usable by the relevant client. Furthermore, Nf is equal to the result obtained by adding the average number of bytes stuffed to the relevant client over many frames. When a stuff ratio is taken as α, the latter is equal to the result obtained by multiplying a by a ratio p of stuff frames of the relevant client. Therefore, from Equation (2), the following Equation can be obtained.

STβ=αp+15,232p−N (4)

A case is explained in which client's asynchronous four CHs are multiplexed to asynchronous ODUk y by using Equation (4). First, a case is explained in which 2.48832 Gb/s is mapped onto ODU1 and four CHs are multiplexed onto ODU2. After 2.48832 Gb/s is mapped onto ODU1 with slave synchronization, four CHs of ODU1 are multiplexed onto ODU2 with an asynchronous server frequency.

Specifically, since

S=2.48832 Gb/s×239/238;

T=3,824×4/(4×2.48832 Gb/s×239/238) (where 3,824×4 represents a frame length of ODU2);

p=0.25 (because the payload of ODU2 is divided into four); and

N=0 (ODU1 has no fixed stuff byte),

when these are substituted into Equation (4), the stuff ratio α can be found as in the following equation.

$$α = \frac{237}{238} \cdot 15 , 296 β - 15 , 232 \qquad ( 5 )$$

When β=1+y (that is, y≡yc−ys (a clock deviation between its own apparatus and the client, i.e., an insertion stuff ratio)), from Equation (5), the stuff ratio α is as in the following equation.

α=−0.2689076+15,231.731092y (6)

Here, when the stuff ratio=0, y can be found as in the following equation.

$$y = \frac{0.2689076}{15 , 231.731092} = 17.6544 \times {10}^{- 6} \qquad ( 7 )$$

Therefore, when the insertion stuff ratio is approximately 17.65 parts per million, α=0 (0 stuff).

Next, a case is explained in which 9.95328 Gb/s is mapped onto ODU2 and four CHs are multiplexed onto ODU3. After 9.95328 Gb/s is mapped onto ODU2 with slave synchronization, four CHs of ODU2 of are multiplexed onto ODU3 with the asynchronous server frequency.

Specifically, since

S=9.95328 Gb/s×239/237;

T=3,824×4/(4×9.95328 Gb/s×239/236)(where 3,824×4 represents a frame length of ODU2); p=0.25 (because the payload of ODU3 is divided into four); and

N=0 (ODU1 has no fixed stuff byte),

when these are substituted into Equation (4), the stuff ratio α can be found as in the following equation.

$$α = \frac{236}{237} \times 15.296 \cdot β - 15 , 232 \qquad ( 8 )$$

When β=1+y, from Equation (8), the stuff ratio α is as in the following equation.

α=−0.5400844+15,231.45992y (9)

Here, when the stuff ratio α=0, y can be found as in the following equation.

$$y = \frac{0.5400844}{15 , 231.45992} = 35.4585 \times {10}^{- 6} \qquad ( 10 )$$

Therefore, when the insertion stuff ratio is approximately 35.46 parts per million, α=0 (0 stuff).

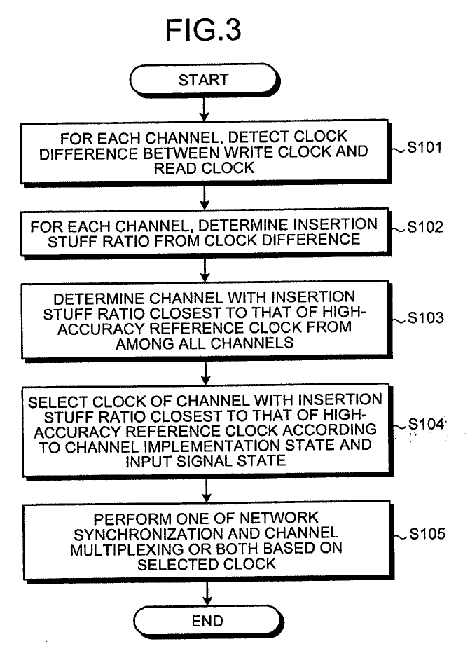

Next, a reference-clock selecting process according to the exemplary embodiment is explained. FIG. 3 is a flowchart of the reference-clock selecting process according to the exemplary embodiment. As depicted in the drawing, first, the frequency-difference detecting unit 11b detects, for each channel, a clock difference between the write clock and the read clock (step S101). Then, the insertion-stuff-ratio determining unit 11c determines, for each channel, an insertion stuff ratio from the clock difference (step S102).

Then, the insertion-stuff-ratio detection-channel determining unit 19a determines a channel with an insertion stuff ratio closest to that of the high-accuracy reference clock from among all channels (step S103). Then, according to a channel implementation state and an input signal state, the CLK selection determining unit 19b selects a clock of the channel with the insertion stuff ratio closest to that of the high-accuracy reference clock (step S104).

The framer and digital wrapper LSI 1b then performs one of network synchronization and channel multiplexing or both based on the clock selected by the CLK selection determining unit 19b (step S105).

According to the exemplary embodiment explained in the foregoing, in an optical interface apparatus having optical interface units that subjects plural channels to digital wrapper for multiplexing, without requiring awareness the channel for transmitting a reference clock, a channel for transmitting a reference clock is automatically specified. Therefore, a test for continuity can be smoothly performed.

Also, since a specific channel is not taken as being dedicated to a clock path, clock synchronization can be automatically achieved with the counterpart communication apparatus without providing any restriction on user's operation, thereby allowing smooth signal communication.

In the foregoing, while the exemplary embodiment of the present invention has been explained, the present invention is not meant to be restricted to this, and can be implemented with further various different embodiments within the range of the technical idea explained in the claims. Also, the effects explained in the exemplary embodiment are not meant to be restrictive.

Furthermore, among the processes explained in the exemplary embodiment, all or part of the processes explained as being automatically performed may be manually performed, or all or part of the processes explained as being manually performed may be automatically performed through a known method. In addition, the process procedure, the control procedure, specific names, and information including various data and parameters disclosed in the exemplary embodiment can be arbitrarily changed unless otherwise specified.

Furthermore, each component depicted is conceptual in function, and is not necessarily physically configured as depicted. That is, the specific patterns of distribution and unification of the components are not meant to be restricted to those depicted in the drawings. All or part of the components can be functionally or physically distributed or unified in arbitrary units according to various loads and the state of use.

Still further, all or arbitrary part of the process functions performed in each component can be achieved by a Central Processing Unit (CPU) (or a microcomputer, such as Micro Processing Unit (MPU) or Micro Controller Unit (MCU)) and a program analyzed and executed on that CPU (or microcomputer, such as MPU or MCU), or can be achieved as hardware with a wired logic.

According to the embodiments of the invention, the advantage is brought about that even if it is not recognized that a specific channel is a channel dedicated to a fixed clock path, the channel dedicated to a fixed clock path can be automatically specified, and that network synchronization can be achieved by a fixed clock transmitted through the dedicated channel.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A reference-clock selection circuit for a communication interface apparatus in which signals are input via a plurality of channels, the reference-clock selection circuit comprising:
an insertion-stuff-bit-amount monitoring unit that monitors an insertion stuff bit amount to be inserted in the signal input via each of the channels;
a channel detecting unit that detects, from among the channels, a channel where the insertion stuff bit amount inserted in the signal matches an insertion stuff bit amount of a reference signal based on a reference clock generated by a reference clock oscillator; and
a reference-clock selecting unit that selects the channel detected by the channel detecting unit as a reference clock for network synchronization of a connected network.

2. The reference-clock selection circuit according to claim 1, wherein
the reference-clock selecting unit monitors a channel implementation state of each of the channels and a warning signal included in each of the signals, and when the signal input via the channel detected by the channel detecting unit does not include the warning signal, selects the channel detected by the channel detecting signal as the reference clock for network synchronization of the connected network.

3. The reference-clock selection circuit according to claim 1, further comprising:
a buffer memory that retains the signal input in each of the channels; and
a frequency-difference detecting unit that detects a difference between a write frequency and a read frequency of the signal,
wherein the insertion-stuff-bit-amount monitoring unit determines the insertion stuff bit amount from the difference between the write frequency and the read frequency of the signal detected by the frequency-difference detecting unit.

4. The reference-clock selection circuit according to claim 1, further comprising a signal multiplexing unit that multiplexes the signals input via the channels with reference to the reference clock.

5. The reference-clock selection circuit according to claim 4, wherein
the signals are optical signals, and
the signal multiplexing unit multiplexes the optical signals input via the channels with a digital wrapper technique.

6. A reference-clock selection method-for a communication interface apparatus in which signals are input via a plurality of channels, the reference-clock selection method comprising:
monitoring an insertion stuff bit amount to be inserted in the signal input via each of the channels;
detecting, from among the channels, a channel where the insertion stuff bit amount inserted in the signal matches an insertion stuff bit amount of a reference signal based on a reference clock generated by a reference clock oscillator; and
selecting the channel detected as a reference clock for network synchronization of a connected network.

7. The method according to claim 6, wherein
selecting the channel monitors a channel implementation state of each of the channels and a warning signal included in each of the signals, and when the signal input via the channel detected does not include the warning signal, selects the channel detected as the reference clock for network synchronization of the connected network.

8. The method according to claim 6, further comprising:
retaining the signal input in each of the channels; and
detecting a difference between a write frequency and a read frequency of the signal, and
wherein monitoring the insertion-stuff-bit-amount determines the insertion stuff bit amount-from the difference between the write frequency and the read frequency of the signal detected by the frequency-difference detecting unit.

9. The method according to claim 6, further comprising multiplexing the signals input via the channels with reference to the reference clock.

10. The method according to claim 9, wherein
the signals are optical signals, and
multiplexing the signal multiplexes the optical signals input via the channels with a digital wrapper technique.

11. A communication interface apparatus in which signals are input via a plurality of channels, comprising:
an insertion-stuff-bit-amount monitoring unit that monitors an insertion stuff bit amount to be inserted in the signal input via each of the channels;
a channel detecting unit that detects, from among the channels, a channel where the insertion stuff bit amount inserted in the signal matches an insertion stuff bit amount of a reference signal based on a reference clock generated by a reference clock oscillator; and
a reference-clock selecting unit that selects the channel detected by the channel detecting unit as a reference clock for network synchronization of a connected network.

12. The communication interface apparatus according to claim 11, wherein
the reference-clock selecting unit monitors a channel implementation state of each of the channels and a warning signal included in each of the signals, and when the signal input via the channel detected by the channel detecting unit does not include the warning signal, selects the channel detected by the channel detecting unit as the reference clock for network synchronization of the connected network.

13. The communication interface apparatus according to claim 11, further comprising:
a buffer memory that retains the signal input in each of the channels; and
a frequency-difference detecting unit that detects a difference between a write frequency and a read frequency of the signal, and
wherein the insertion-stuff-bit-amount monitoring unit determines the insertion stuff bit amount from the difference between the write frequency and the read frequency of the signal detected by the frequency-difference detecting unit.

14. The communication interface apparatus according to claim 11, further comprising a signal multiplexing unit that multiplexes signals input via the channels with reference to the reference clock.

15. The communication interface apparatus according to claim 14, wherein
the signals are optical signals, and
the signal multiplexing unit multiplexes the optical signals input via the channels with a digital wrapper technique.
